(19) United States
(12) Patent Application Publication
(10) Pub. No.: US 2015/0278924 A1
(43) Pub. Date: Oct. 1, 2015

(54) PURCHASE PRICE OPTIMIZATION FOR PRESCRIPTION PRODUCT PURCHASE ORDERS

(71) Applicant: MCKESSON CORPORATION, San Francisco, CA (US)

(72) Inventors: Andrew Maurer, Atlanta, GA (US); Angela Codding, Phoenix, AZ (US); Richard Selby, Duluth, GA (US)

(73) Assignee: MCKESSON CORPORATION, San Francisco, CA (US)

(21) Appl. No.: 14/231,256

(22) Filed: Mar. 31, 2014

(51) Int. Cl. G06Q 30/06

(52) U.S. Cl. CPC G06Q 30/0635

(57) ABSTRACT

Systems, methods, and computer-readable media for performing purchase price optimization for a prescription product purchase order are disclosed. At least a portion of a desired quantity of the prescription product that is not eligible for reduced pricing may be substituted for one or more generic products corresponding to the prescription product that are eligible for reduced pricing.

### TECHNICAL FIELD

This disclosure relates generally to purchase price optimization for prescription product purchase orders, and more particularly, to identifying a generic equivalent that can be purchased at one or more reduced prices and substituted for at least a portion of the desired quantity of a corresponding prescription product.

### BACKGROUND

Various government sponsored and non-government sponsored programs and entities exist for providing reduced costs for prescription products such as prescription medications, medical devices, and other prescription products. Such programs or entities may include, for example, the federal 340B drug pricing program, healthcare group purchasing organizations (GPOs), patient assistance programs (PAPs) available through pharmaceutical companies or governmental organizations such as Medicare or Medicaid, and so forth.

In 1992, Section 340B of the Public Health Service Act was enacted under Section 602 of the Veterans Healthcare Act of 1992. Section 340B requires drug manufacturers to provide outpatient drugs to eligible healthcare centers, clinics, and hospitals (referred to as “covered entities”) at a reduced price. This reduced price (sometimes interchangeably referred to as the “340B price,” the “Public Health Service (PHS) price,” the “602 price,” or the like) represents a price that a covered entity would have to pay for select prescription drugs dispensed on an outpatient basis and is often significantly lower than the Wholesale Acquisition Cost (WAC) price for such drugs.

A “covered drug” under the 340B program may include, for example, a Federal Drug Administration (FDA) approved prescription drug, an over-the-counter (OTC) drug that is written on a prescription, and so forth. Covered entities eligible to participate in the 340B program generally include entities that serve indigent or historically disenfranchised populations or that focus on treating particular disease conditions such as, for example, federally-qualified health centers, hospitals that treat indigent patients through a disproportionate share hospital (DSH) program, children's hospitals, free standing cancer clinics, family planning projects, state-operated AIDS Drug Assistance Programs (ADAPs), black lung clinics receiving federal funds, and so forth. Prescription drug purchases at the 340B price represent a significant cost savings over the typical costs for such drugs. The cost savings can, in turn, be passed on to patients, thereby reducing the overall cost of patient care to both healthcare providers and patients.

The 340B program specifies a number of restrictions on the type of prescription drugs and the conditions under which such drugs must be prescribed and dispensed in order to qualify for 340B pricing. For example, a covered drug may need to be dispensed in an outpatient setting to qualify for 340B pricing. It is often difficult for covered entities (e.g., hospital pharmacies) to effectively track the conditions under which prescription drugs are dispensed (e.g., whether a drug was dispensed to an outpatient or an inpatient), and thus, it may be difficult for covered entities to ensure that they are receiving the best possible price when replenishing their inventory (e.g., a 340B price).

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic depiction of an illustrative system architecture for performing purchase price optimizations for prescription product purchase orders in accordance with one or more example embodiments of the disclosure.

FIG. 2 depicts hardware and software components of an illustrative price optimization computer in accordance with one or more example embodiments of the disclosure.

FIG. 3 is an illustrative hybrid system and data flow diagram depicting example data communications in connection with a purchase price optimization for a prescription product purchase order in accordance with one or more example embodiments of the disclosure.

FIGS. 4A-4B are process flow diagrams of an illustrative method for performing a purchase price optimization for a prescription product purchase order in accordance with one or more example embodiments of the disclosure.

### DETAILED DESCRIPTION OF EXAMPLE EMBODIMENTS

### Overview

Example embodiments of the disclosure relate to systems, methods, computer-readable or machine-readable media, techniques, and methodologies for performing purchase price optimizations for prescription product purchase orders. While example embodiments of the disclosure may be described in connection with prescription drugs eligible for reduced pricing under a sponsored program (e.g., the federal 340B drug pricing program), it should be appreciated that embodiments of the disclosure are applicable to any prescription product eligible for reduced pricing under any suitable pricing program.

Various government or non-government sponsored programs exist for providing covered entities with prescription drugs at reduced prices. One such program is the federal 340B drug pricing program. The 340B price for a prescription drug is often significantly lower than the WAC price for the drug that non-covered entities such as retail pharmacies typically pay. While a lower price than the WAC price may be available under various other pricing programs (such as a GPO price available to a member of a GPO), the 340B price for a prescription drug is generally the lowest price at which the drug can be purchased.

In order to be eligible to purchase a prescription drug at the 340B price, however, a covered entity must meet certain requirements. One such requirement may be that the prescription drug be a covered prescription drug that qualifies for 340B pricing. Another requirement may be that the prescription drug be dispensed to an outpatient. For example, a covered entity such as a DSH hospital, children's hospital, or the like may be required to dispense the prescription drug to an outpatient in order to qualify for 340B pricing for the drug.

In certain example scenarios, a covered entity may contract with a non-covered entity (e.g., a retail pharmacy) such that a covered entity may replenish the prescription drug at the 340B price despite the fact that a non-covered entity (the retail pharmacy) dispensed the drug. In such scenarios, the retail pharmacy may continue to purchase the drug at the WAC price while the covered entity may be allowed to replenish its own inventory of the drug at the 340B price. While the retail pharmacy may charge the covered entity a service fee under the contract, the arrangement may nonetheless be advantageous for the covered entity because the sum of the service charge and the 340B price for the drug may still be less (potentially significantly less) than the WAC price.

In such scenarios, in order to be eligible for the 340B price, the covered entity may need to demonstrate that the prescription drug is used to treat a condition for which the patient that received the drug sought treatment by the covered entity. This may be demonstrated, for example, by a correspondence between an identifier of the prescription drug (e.g., a National Drug Code (NDC)) and a diagnosis code specified in a patient health record maintained at the covered entity that indicates the condition for which the patient was treated by the covered entity as well as an identifier associated with the treating physician such as a National Provider Identifier (NPI) or a Drug Enforcement Agency (DEA) number.

In order to purchase a prescription drug at the corresponding 340B price, dispensing data for the covered entity must indicate that a number of qualifying dispensed units of the drug satisfies a corresponding replenishment increment threshold. As used herein, the term “qualifying dispensed unit,” “reduced price qualifying dispensed unit,” or a similar variant thereof may refer to the smallest unit of a drug that can be dispensed under conditions that satisfy the requirements of a reduced pricing program such as the 340B pricing program. As previously noted, one such requirement may be that the dispensed unit of the drug be dispensed in an outpatient setting.

The “replenishment increment threshold” may correspond to the number of qualifying dispensed units needed to replenish an incremental quantity of the prescription drug at a reduced price. In order to receive a reduced price such as a 340B price, a covered entity may need to purchase a prescription drug in incremental amounts where each incremental amount corresponds to a fixed amount of the drug. For example, in the case of a prescription drug that is dispensed in discrete units (e.g., a pill, capsule, tablet, etc.), the minimum incremental amount that may need to be purchased may be a fixed number of units of the drug (e.g., a bottle containing 100 pills). Further, each pill, capsule, or tablet that is dispensed may constitute a dispensed unit. As such, multiple units may be dispensed to a single patient such as when a patient fills a prescription for 30 pills of a prescription drug.

As another non-limiting example, in the case of a prescription drug that is dispensed as a fluid or semi-fluid (e.g., a liquid or gel), the minimum incremental amount that may need to be purchased in order to obtain reduced pricing may be a fixed volume or weight of the drug. A dispensed unit for such a drug may correspond to some fixed volume or weight of the drug that represents a portion of the minimum incremental amount. For example, 15 ml of a prescription drug may constitute a dispensed unit while 300 ml may constitute the minimum incremental quantity that can be purchased. A dispensed unit for a drug delivered in liquid or gel form may be determined based on dosing requirements for the drug.

Despite the theoretical availability of a 340B price for a drug, there are a number of scenarios in which a covered entity may not be able to obtain the 340B price for the drug. In one such example scenario, the prescription drug may be a recently approved drug that a covered entity has not purchased before, and thus, no dispensing data may be available for the drug. As such, the covered entity may not be able to demonstrate a sufficient number of qualifying dispensed units.

In another example scenario, the dispensing data reported by a covered entity may be stale data that fails to indicate a sufficient number of dispensed units of a drug in order to qualify for 340B pricing for the drug. As a non-limiting example, a covered entity may continue to report dispensing data for a prescription drug having a particular NDC (e.g., NDC A) despite actually dispensing a replacement prescription drug having a different NDC (e.g., NDC B). Accordingly, when the covered entity attempts to purchase NDC B at the corresponding 340B price, the dispensing data (which demonstrates dispensing of NDC A and not NDC B) may reflect an insufficient number of dispensed units of NDC B to qualify for the 340B price for NDC B.

In yet another example scenario, a covered entity may dispense a compound item that includes multiple prescription drugs each of which may have a corresponding NDC. In such scenarios, the covered entity may actually generate a new NDC to identify the compound item. Accordingly, the dispensing data for the compound item may indicate the new NDC rather than the NDCs for the component prescription drugs of the compound item, and thus, the covered entity may fail to accumulate a sufficient number of qualifying dispensed units for any of the component prescription drugs to qualify for 340B pricing.

As a result of the types of example scenarios discussed above, covered entities are increasingly finding themselves having to replenish their prescription drug inventory at the higher WAC prices rather than the reduced 340B prices for such drugs. In addition, due to recent changes to the 340B pricing program, certain types of covered entities (e.g., DSH hospitals) may be required to purchase a prescription drug at the WAC price despite qualifying for purchasing the drug at a lower price such as a GPO price. That is, even in those scenarios in which a covered entity has not accumulated enough dispensed units of a drug to qualify for the 340B price for the drug, but does qualify for a GPO price, the covered entity may nonetheless be required to purchase at the WAC price depending on the type of covered entity.

Example embodiments of the disclosure relate to algorithmic processes and associated systems for executing such processes to optimize the purchase price of a prescription drug purchase order such that the amount of the drug purchased at a higher price (e.g., a WAC price) is minimized and the amount of the drug purchased at reduced prices such as a 340B price or a GPO price is maximized.

In an example embodiment of the disclosure, a price optimization system that may include one or more price optimization computers may receive a purchase order on behalf of a covered entity such as a DSH hospital. The purchase order may specify a desired quantity of a prescription drug. For ease of explanation, the purchase order will be assumed to be an order of a desired quantity of only a single prescription drug; however, it should be appreciated that the purchase order may specify desired quantities for multiple prescription drugs. The purchase order may be submitted, for example, via a purchase order web portal.

Upon receipt of the purchase order, the price optimization system may determine, based on dispensing data relating to dispenses of the prescription drug by the covered entity, whether the covered entity has accumulated enough qualifying dispense units to satisfy a replenishment threshold for the desired quantity of the prescription drug. For example, the purchase order may be for 5 bottles of a prescription drug dispensed in tablet form where each bottle contains 100 tablets. As such, in this illustrative example, the replenishment increment threshold is 100 and the replenishment threshold for the desired quantity specified in the purchase order is 500.

If the covered entity has accumulated enough qualifying dispensed units to satisfy the replenishment threshold for the desired quantity of the drug (e.g., the dispensing data indicates that at least 500 tablets were cumulatively dispensed to one or more outpatients), then the covered entity may be permitted to replenish its inventory with the desired quantity of the drug at the 340B price.

In those scenarios in which the dispensing data fails to indicate a sufficient number of qualifying dispensed units to purchase the entire desired quantity, the covered entity would have conventionally been required to purchase one or more replenishment increments of the drug at a higher price such as the WAC price. For example, if the covered entity is seeking to purchase 5 100-pill bottles of a prescription drug and has only accumulated enough qualifying dispensed units to purchase 2 bottles at the 340B price, the covered entity would be required to purchase the additional 3 bottles at a GPO price or a WAC price under conventional solutions. Moreover, as a result of the changes to the 340B pricing program noted above, even if the GPO price is available for one or more of the 3 bottles, certain types of covered entities may be required to purchase the 3 bottles at the WAC price.

In contrast to conventional solutions, in those scenarios in which a covered entity has failed to accumulate enough qualifying dispensed units to obtain 340B pricing for an entire desired quantity of a prescription drug, the price optimization system may be configured to perform processing to determine whether a generic equivalent of the prescription drug can be purchased at one or more reduced prices in lieu of purchasing the prescription drug at a higher price such as the WAC price.

More specifically, the price optimization system may determine a price breakdown for the prescription drug based on the dispensing data available for the prescription drug. Continuing with the example introduced above, the price optimization system may determine that 2 bottles of the prescription drug can be purchased at the 340B price while 3 bottles must be purchased at the WAC price.

The price optimization system may also receive information identifying generic equivalents for the prescription drug. As used herein, a “generic equivalent” of a prescription drug may refer to a drug that is comparable to the prescription drug in dosage from, strength, route of administration, quality and performance characteristics, and/or intended use. Upon receiving the generic equivalents information, the price optimization system may select a predetermined number of candidate generic equivalents based on pricing data and distribution center inventory data available for the generic equivalents.

More specifically, the price optimization system may rank the generic equivalents based on the pricing data and distribution center inventory data. For example, a generic equivalent that has a lower reduced price (e.g., a lower 340B price) may be ranked higher than a generic equivalent that has a higher reduced price. Similarly, if the distribution center data indicates that the distribution center inventory includes a sufficient quantity of a particular generic equivalent to meet the desired quantity of the prescription drug specified in the purchase order, that generic equivalent may be ranked higher than another generic equivalent that is not adequately stocked at the distribution center. The price optimization system may then select a predetermined number of highest ranking generic equivalents as candidates for substituting for at least a portion of the desired quantity of the prescription drug.

Upon selecting the candidate generic equivalents, the price optimization system may select a particular generic equivalent that has the greatest quantity eligible for purchase at a reduced price such as the 340B price or a particular generic equivalent that has the lowest combined price for the desired quantity. More specifically, in certain example embodiments, the price optimization system may determine, for each candidate generic equivalent, a respective quantity of the candidate generic equivalent that can be purchased at a reduced price such as the 340B price (e.g., the number of replenishment increments that can be purchased at the 340B price). This determination may be based on dispensing data indicating qualifying dispensed units by the covered entity for each of the candidate generic equivalents.

Referring again to the non-limiting example involving a purchase order for 5 100-tablet bottles of a prescription drug, and assuming that two generic equivalents (e.g., generic equivalent A and generic equivalent B) have been identified as candidates, the dispensing data for generic equivalent A may indicate that the covered entity dispensed 312 qualifying dispensed units of generic equivalent A and 415 qualifying dispensed units of generic equivalent B. In such an example scenario, the price optimization system may determine that 3 bottles of generic equivalent A can be purchased at the corresponding 340B price, 1 bottle can be purchased at a GPO price, and 1 bottle must be purchased at the WAC price. Similarly, for generic equivalent B, the price optimization system may determine that 4 bottles of generic equivalent B can be purchased at the corresponding 340B price and that the remaining bottle must be purchased at the WAC price.

In the example scenario described above, since a greater quantity of generic equivalent B is eligible for purchase at the 340B price as compared to generic equivalent A, generic equivalent B may be selected as the optimized generic equivalent to potentially substitute for the prescription drug originally specified in the purchase order. In alternative embodiments, if the combined price of the purchase of 5 bottles of generic equivalent A is less than the combined price of the purchase of 5 bottles of generic equivalent B, generic equivalent A may instead be selected as the optimized generic equivalent to potentially substitute for the prescription drug originally specified in the purchase order.

Upon selecting a particular generic equivalent, the price optimization system may generate proposed updated purchase order information by substituting at least the quantity of the prescription drug required to be purchased at the WAC price for an equivalent quantity of the selected generic equivalent eligible for purchase at a reduced price such as the 340B price, and may communicate the proposed updated purchase order information for presentation to the representative of the covered entity that submitted the original purchase order.

The representative (e.g., a wholesale purchaser) acting on behalf of the covered entity may be provided with the option of accepting the proposed purchase order, modifying it, or cancelling it. Modifications to the proposed purchased order may include removing any incremental quantities that must be purchased at the WAC price that might remain in the proposed purchase order. In certain example embodiments, the modified or accepted purchase order may be received by the price optimization system which may, in turn, communicate the modified or accepted purchase order to a wholesale fulfillment system for fulfillment. In other example embodiments, the modified or accepted purchase order may be communicated via the web portal to the wholesale fulfillment system without the further involvement of the price optimization system. In such embodiments, however, the price optimization system may nonetheless receive a notification that the proposed order has been accepted or modified. Upon receiving an indication that a purchase order has been submitted (e.g., a proposed purchase order has been accepted or modified and submitted for fulfillment), the price optimization system may update corresponding dispensing data to remove any accumulations of qualifying dispensed units that served as a basis for obtaining a replenishment increment of a drug.

While example embodiments described herein may indicate that a particular generic equivalent may be chosen to replace at least a portion of the desired quantity of a prescription drug in a purchase order, it should be appreciated that various combinations of generic equivalents may be chosen in certain example embodiments. Referring again to the non-limiting example introduced above, various combinations of generic equivalent A and generic equivalent B may be purchased at the 340B price in a quantity sufficient to match the entire desired quantity of the prescription drug. For example, if an amount of qualifying dispensed units accumulated for the prescription drug are insufficient to satisfy the minimum replenishment threshold for even a single replenishment increment at the 340B price, the purchase order may be updated to entirely remove the original prescription product and to instead include 4 bottles of generic equivalent B at the 340B price and 1 bottle of generic equivalent A at the 340B price. In addition, in certain example embodiments, even if some portion of the desired quantity of the prescription drug is available for purchase at the 340B price, the prescription drug may nonetheless be entirely substituted for one or more generic equivalents that are eligible for reduced pricing for the entire desired quantity. In still other embodiments, an amount of a generic equivalent equal to the entire desired quantity of the prescription drug may be substituted for the prescription drug even if some portion of the generic equivalent must be purchased at a higher price such as the WAC price.

Example embodiments disclosed herein provide a number of technical effects or advantages over conventional solutions including, without limitation, providing significant cost savings to a covered entity by identifying generic equivalents that can be purchased at a reduced price such as a 340B price in greater quantities than a corresponding prescription drug can be purchased and modifying a purchase order to substitute the identified generic equivalents for at least a portion of the desired quantity of the prescription drug.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. In addition, it should be appreciated that the example technical effects described above are merely illustrative and not exhaustive. The above-described embodiments and additional and/or alternative embodiments of the disclosure will be described in detail hereinafter through reference to the accompanying drawings.

### Illustrative System Architecture

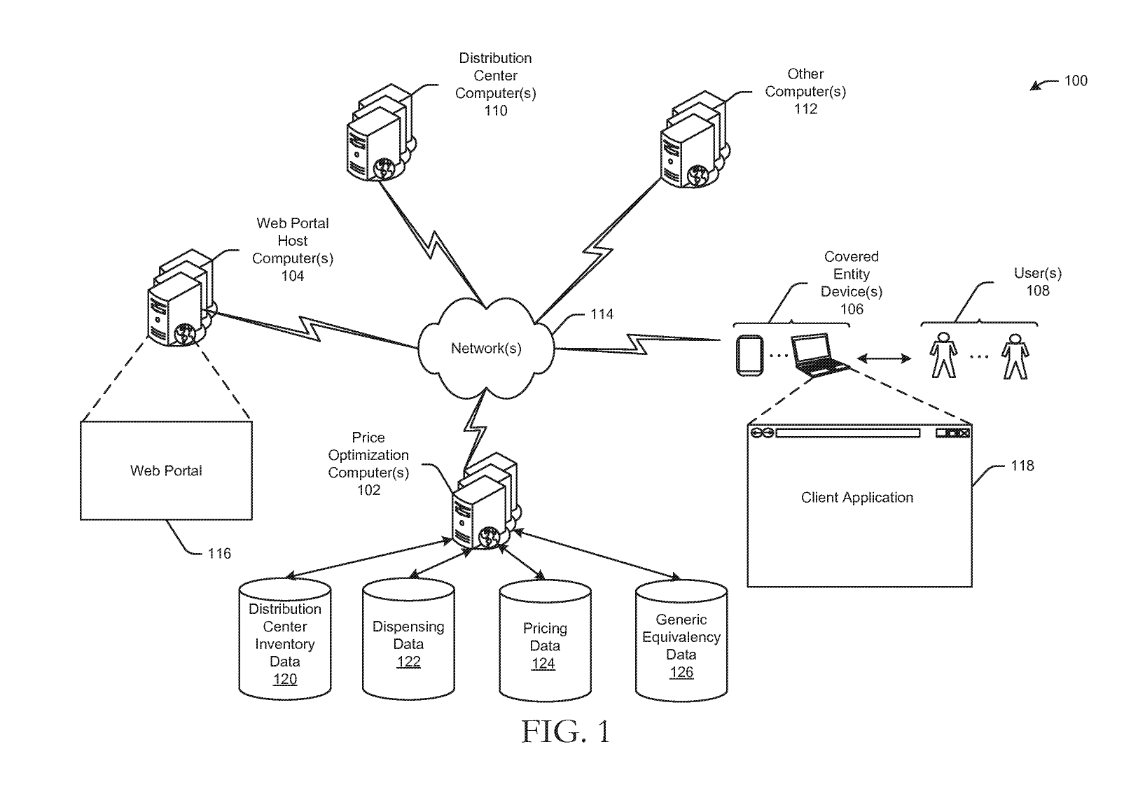

FIG. 1 is a schematic depiction of an illustrative system architecture 100 for performing purchase price optimizations for prescription product purchase orders in accordance with one or more example embodiments of the disclosure.

The system architecture 100 may include one or more price optimization computers 102 (at times collectively referred to herein as a price optimization system), one or more web portal host computers 104, one or more covered entity devices 106 operable by one or more users 108, one or more distribution center computers 110, and one or more other computers 112. While the price optimization computer(s) 102, the web portal host computer(s) 104, the covered entity device(s) 106, the distribution center computer)(s) 110, and the other computer(s) 112 may at times be referred to herein in the singular, it should be appreciated that multiple ones of any of the components of the architecture 100 may be provided.

One or more of the price optimization computer 102, the web portal host computer 104, the covered entity device 106, the distribution center computer 110, or the other computer 112 may include one or more processing units that may be configured to access and read computer-readable media having stored thereon data and/or computer-executable instructions for implementing various functionality described herein. Any of the illustrative components of the architecture 100 may include or otherwise be associated with suitable hardware, firmware, and/or software components for transmitting and receiving data and/or computer-executable instructions over one or more communications links or networks. These networked devices and systems may also include any number of processors for processing data and executing computer-executable instructions, as well as other internal and peripheral components. Further, these networked devices and systems may include or be in communication with any number of suitable memory devices operable to store data and/or computer-executable instructions. By storing and/or executing computer-executable instructions, each of the networked devices may form a special purpose computer or a particular machine. As used herein, the term “computer-readable medium” describes any form of suitable memory or data storage device.

In addition, any of the illustrative components of the architecture 100 may be configured to communicate with one or more other components of the architecture via one or more networks 114. The network(s) 114 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 114 may have any suitable communication range associated therewith and may include, for example, global networks (e.g., the Internet), metropolitan area networks (MANs), wide area networks (WANs), local area networks (LANs), or personal area networks (PANs). In addition, the network(s) 114 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

The network(s) 114 may allow for real-time, off-line, and/or batch transactions to be transmitted between or any of the illustrative components of the architecture. In one or more example embodiments, the illustrative system architecture 100 may be implemented in the context of a distributed computing environment. Further, it should be appreciated that the illustrative system architecture 100 may be implemented in accordance with any suitable network configuration. For example, the network(s) 114 may include a plurality of networks, each with devices such as gateways, routers, linked-layer switches, and so forth for providing connectivity between or among the various devices forming part of the system architecture 100. In some example embodiments, dedicated communication links may be used to connect the various devices of the architecture 100.

The price optimization computer 102 may be configured to access various datastores storing various types of data. The datastores may include, for example, one or more datastores storing distribution center inventory data 120, one or more datastores storing dispensing data 122, one or more datastores storing pricing data 124, and/or one or more datastores storing generic equivalency data 126. While the various types of data are illustratively depicted in FIG. 1 as being stored in separate datastores, it should be appreciated that any portion of any of the types of data may be stored in one or more of the same datastores. Further, the types of data depicted in FIG. 1 are merely illustrative and not exhaustive.

The distribution center inventory data 120 may have been received from the distribution center computer 110 and may indicate quantities of various prescription drugs and generic equivalents that are in stock and available for shipment to covered entity locations.

The dispensing data 122 may indicate various information relating to prescription drug dispensing by covered entities such as, for example, the number of qualifying dispensed units accumulated for various prescription drugs and generic equivalents. As previously noted, a qualified dispensed unit may correspond to a smallest unit of a drug that can be dispensed under conditions that satisfy the requirements of a reduced pricing program. A covered entity may need to accumulate a number of qualifying dispensed units that satisfies a minimum replenishment threshold before being eligible to purchase an increment of the corresponding drug.

The price optimization computer 102 may receive the dispensing data 122 relating to a particular covered entity from the covered entity itself as part of, for example, a drug utilization file or as part of healthcare claim transaction data such as prescription claim transaction data. The price optimization computer 102 may receive the prescription claim data from a service provider computer 112 configured to route healthcare claim transactions between healthcare providers and claims processors.

The dispensing data 122 for a drug may include multiple data records with each data record corresponding to a particular dispensing of the drug. Each data record may indicate the number of dispensed units and whether the units were dispensed to an inpatient or an outpatient. For example, a code or other identifier may be included in the data record to indicate whether the dispensing occurred in an outpatient setting or not. In certain example embodiments, the price optimization computer 102 may be configured to locate, within a data record, a data field designated for specifying whether the dispensing was outpatient or not and extract the data populated in the data field. The price optimization computer 102 may then query a database or otherwise compare the extracted data against a schedule, listing, or the like to determine whether the code identifies an outpatient or an inpatient. In certain example embodiments, the data record may be a healthcare claim prescription such as a prescription claim transaction.

The pricing data 124 may include information specifying 340B prices, GPO prices, WAC prices, and so forth for various prescription drugs and generic equivalents. The price optimization computer 102 may have received the pricing data 124 from one or more other computers 112 such as, for example, one or more computers operated by a prescription drug purchasing organization.

In addition, the generic equivalency data 126 may identify generic equivalents that exist for any given prescription drug and associated information such as dosing information or the like. The price optimization computer 102 may have previously received the generic equivalency data 126 from one or more other computers 112 such as, for example, from one or more computers operated by a prescription drug purchasing organization.

A user 108 acting on behalf of a covered entity may utilize a covered entity device 106 to access a web portal 116 hosted by the web portal host computer 104. More specifically, the user 108 may utilize a client application 118 (e.g., a web browser, a dedicated web portal application, etc.) executing on the covered entity device 106 to access the web portal 116. The web portal 116 may include one or more user interfaces for submitting a prescription drug purchase order. The one or more user interfaces of the web portal 116 may be presented to the user 108 via the client application 118. As will be described in more detail hereinafter, the price optimization computer 102 may receive information pertaining to the prescription drug purchase order submitted via the web portal 116 and may perform purchase price optimization processing for the purchase order. The purchase price optimization processing may include processing to determine whether a quantity of one or more generic equivalents of the prescription drug are available for purchase at a reduced price such as a 340B price such that the quantity of the generic equivalent(s) can be substituted for a corresponding quantity of the prescription drug that must be purchased at a higher price such as a WAC price.

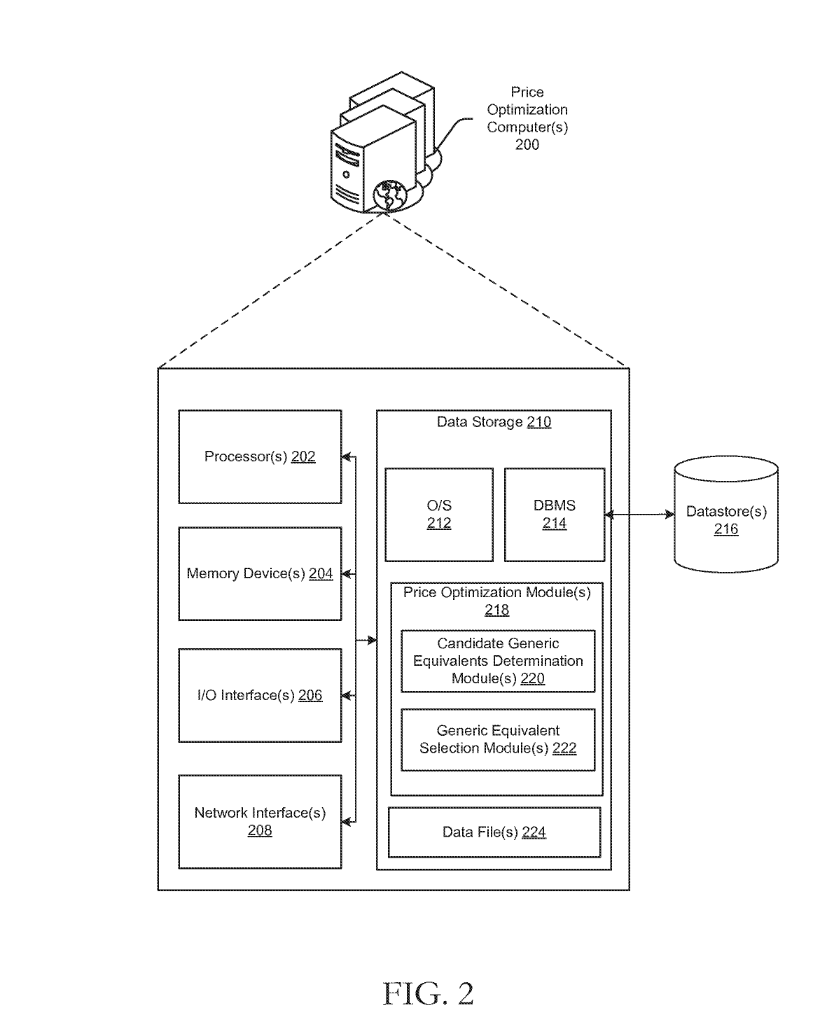

FIG. 2 depicts hardware and software components of an illustrative price optimization computer 200 in accordance with one or more example embodiments of the disclosure. In certain example embodiments, the price optimization computer 200 may be included among the one or more price optimization computers 102.

In an illustrative configuration, the price optimization computer 200 may include one or more processors (processor(s)) 202, one or more memory devices 204 (generically referred to herein as memory 204), one or more input/output (“I/O”) interface(s) 206, one or more network interface(s) 208, and data storage 210. These various components will be described in more detail hereinafter.

The memory 204 of the price optimization computer 200 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 204 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 204 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 210 may include removable storage and/or non-removable storage including, but not limited to, magnetic storage, optical disk storage, and/or tape storage. The data storage 210 may provide non-transient storage of computer-executable instructions and other data. The data storage 210 may include storage that is internal and/or external to the price optimization computer 200. The memory 204 and the data storage 210, removable and/or non-removable, are examples of computer-readable storage media (CRSM) as that term is used herein.

The data storage 210 may store computer-executable instructions that are loadable into the memory 204 and executable by the processor(s) 202 to cause various operations to be performed. The data storage 210 may additionally store data that may be copied to memory 204 for use by the processor(s) 202 during the execution of the computer-executable instructions. Moreover, output data generated as a result of execution of the computer-executable instructions by the processor(s) 202 may be stored initially in memory 204, and may ultimately be copied to data storage 210 for non-transient storage.

More specifically, the data storage 210 may store one or more operating systems (O/S) 212; one or more database management systems (DBMS) 214; one or more program modules, applications, or the like such as, for example, one or more price optimization modules 218, one or more candidate generic equivalents determination module(s) 220, and one or more generic equivalent selection module(s) 222; and various data file(s) 224. While the candidate generic equivalents determination module(s) 220 and the generic equivalent selection module(s) 222 are depicted as sub-modules of the price optimization module(s) 218, it should be appreciated that the functionality supported by any of the modules 218, 220, or 222 may be modularized in any suitable way.

The price optimization module(s) 218 may include computer-executable instructions that responsive to execution by one or more of the processor(s) 202 may cause operations to be performed in connection with purchase price optimization of a prescription drug purchase order. For example, computer-executable instructions of the price optimization module(s) 218 may be executed to determine whether an entire desired quantity of a prescription drug specified in a purchase order is eligible for purchase at a reduced price such as a 340B price.

If the price optimization module(s) 218 determine that some portion of the desired quantity of the prescription drug is not eligible for purchase at the 340B price and must be purchased at, for example, the WAC price, computer-executable instructions of the price optimization module(s) 218 and/or one or more of sub-modules 220 or 222 may be executed to perform further purchase price optimization with respect to generic equivalents of the prescription.

For example, computer-executable instructions of the candidate generic equivalents determination module(s) 220 may be executed to identify generic equivalents of the prescription drug, rank the generic equivalents based on pricing data and distribution center inventory data, and select a predetermined number of the highest ranking generic equivalents as candidate generic equivalents to purchase in lieu of at least a portion of the desired quantity of the prescription drug.

Further, computer-executable instructions of the generic equivalent selection module(s) 222 may be executed to identify a particular generic equivalent associated with the largest quantity eligible for purchase at a reduced price such as a 340B price. Alternatively, the computer-executable instructions of the generic equivalent selection module(s) 222 may be executed to identify a generic equivalent eligible for purchase at the lowest combined price. In still other example embodiments, multiple generic equivalents may be selected to replace at least a portion of the desired quantity of the prescription drug or potentially an entire desired quantity of the prescription drug.

In certain example embodiments, the generic equivalent eligible for purchase at the lowest combined price may not be the same as the generic equivalent associated with the largest quantity eligible for purchase at the lowest price (e.g., the 340B price). For example, 7 replenishment increments of generic equivalent A may be eligible for purchase at 340B pricing and 3 replenishment increments may be required to be purchased at WAC pricing. In contrast, 5 replenishment increments of generic equivalent B may be eligible for purchase at the 340B while the other 5 replenishment increments may be available for purchase at a GPO price. Thus, while generic equivalent B has less replenishment increments available for purchase at the 340B price, it may nonetheless have the lowest combined price if the WAC price is significantly more than the GPO price.

Upon selection of one or more generic equivalents, the price optimization module(s) 218 may generate proposed updated purchase order information by substituting some quantity of the one or more generic equivalents for a corresponding quantity of the prescription drug. The proposed updated purchase order information may be presented to the representative of the covered entity that submitted the original purchase order and may be accepted, modified, or canceled by the representative of the covered entity.

As a non-limiting example of a proposed updated purchase order, if 5 replenishment increments of the prescription drug must be purchased at the WAC price, a total of five increments of one or more generic equivalents eligible for purchase at the 340B price and/or a GPO price may be substituted for the 5 WAC price replenishment increments. In other example embodiments, one or more generic equivalents may be substituted for the entire desired quantity of the prescription drug even if some quantity of the prescription drug is eligible for purchase at a 340B price and/or even if some quantity of the one or more generic equivalents must be purchased at the WAC price.

As part of the processing described above, the price optimization module(s) 218 and/or sub-modules thereof may utilize input data included among the data file(s) 224 and/or store output data as part of the data file(s) 224. The data file(s) 224 may include any of the example types of data depicted in FIG. 1. In addition, any of the example types of data depicted in FIG. 1 as well as any suitable output data generated from purchase price optimization processing (e.g., proposed updated purchase order information) may be stored in one or more datastores 216.

Referring now to other illustrative components of the price optimization computer 200, the O/S 212 may be loaded into the memory 204 and may provide an interface between other application software executing on the price optimization computer 200 and hardware resources of price optimization computer 200. More specifically, the O/S 212 may include a set of computer-executable instructions for managing hardware resources of the price optimization computer 200 and for providing common services to other application programs (e.g., managing memory allocation among various application programs). The O/S 212 may include any operating system now known or which may be developed in the future including, but not limited to, any server operating system, any mainframe operating system, or any other proprietary or non-proprietary operating system.

The DBMS 214 may be loaded into the memory 204 and may support functionality for accessing, retrieving, storing, and/or manipulating data stored in one or more of the datastores (not shown), data stored in the memory 204, and/or data stored in the data storage 210. The DBMS 214 may use any of a variety of database models (e.g., relational model, object model, etc.) and may support any of a variety of query languages. The datastore(s) may include any suitable data repository including, but not limited to, databases (e.g., relational, object-oriented, etc.), file systems, flat files, distributed datastores in which data is stored on more than one node of a computer network, peer-to-peer network datastores, or the like. Any of the datastore(s) may represent data in one or more data schemas.

The processor(s) 202 may be configured to access the memory 204 and execute computer-executable instructions stored therein. For example, the processor(s) 202 may be configured to execute computer-executable instructions of the various program modules of the price optimization computer 200 to cause or facilitate various operations to be performed in accordance with one or more embodiments of the disclosure. The processor(s) 202 may include any suitable processing unit capable of accepting data as input, processing the input data in accordance with stored computer-executable instructions, and generating output data. The processor(s) 202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 202 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 202 may be capable of supporting any of a variety of instruction sets.

The price optimization computer 200 may further include one or more input/output (I/O) interfaces 206 that may facilitate the receipt of input information by the price optimization computer 200 from one or more I/O devices as well as the output of information from the price optimization computer 200 to the one or more I/O devices. The I/O devices may include, for example, one or more user interface devices that facilitate interaction between a user and the price optimization computer 200 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

As previously noted, the price optimization computer 200 may be configured to communicate with any of a variety of other systems, platforms, networks, devices, and so forth (e.g., a user device 106, a web portal host computer 104, a distribution center computer 110, one or more other computers 112, etc.) via one or more of the network(s) 114. The price optimization computer 200 may include one or more network interfaces 208 that may facilitate communication between the price optimization computer 200 and any of the systems, networks, platforms, devices, or components of the system architecture 100.

It should be appreciated that the program modules, applications, computer-executable instructions, code, or the like depicted in FIG. 2 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the price optimization computer 200 and/or hosted on other computing device(s) accessible via one or more of the network(s) 114 may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices of the system architecture 100 in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

It should further be appreciated that the price optimization computer 200 or any illustrative component of the system architecture 100 may include alternate and/or additional hardware, software, or firmware components beyond those described or depicted without departing from the scope of the disclosure. More particularly, it should be appreciated that software, firmware, or hardware components depicted as forming part of price optimization computer 200 are merely illustrative and that some components may not be present or additional components may be provided in various embodiments. While various illustrative program modules have been depicted as software modules stored in data storage, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

### Illustrative Data Flows and Illustrative Processes

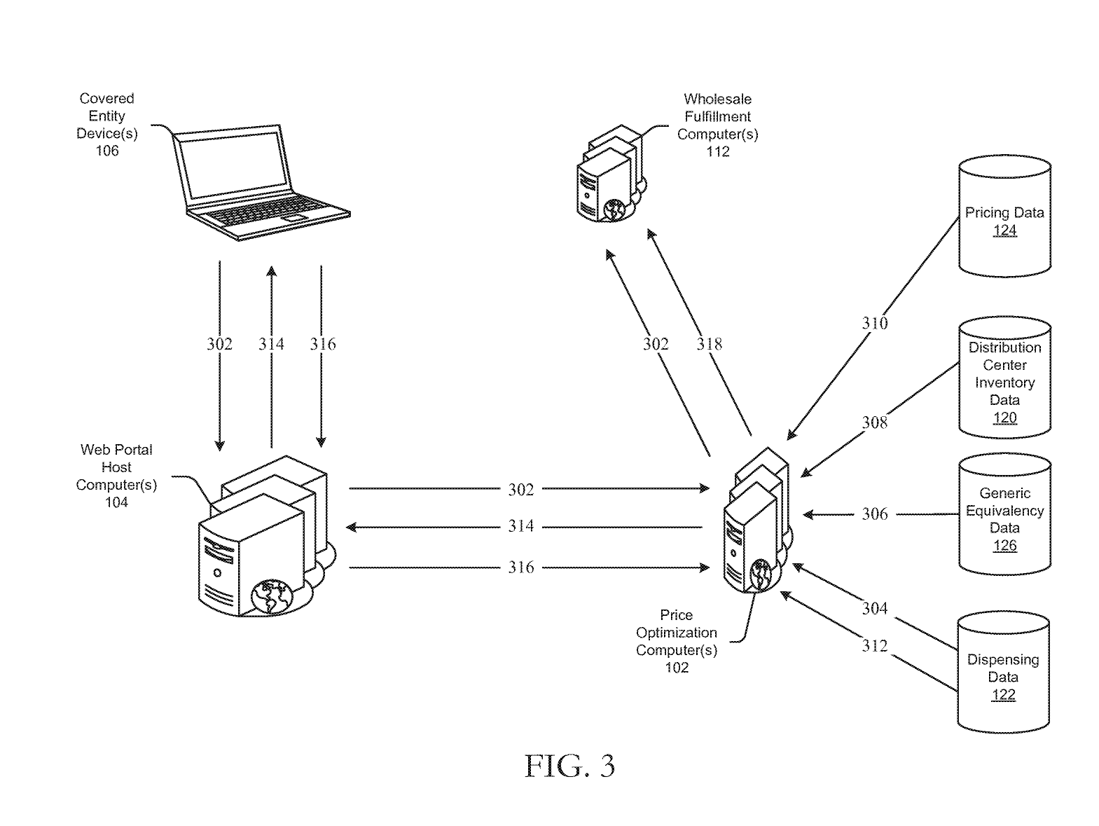

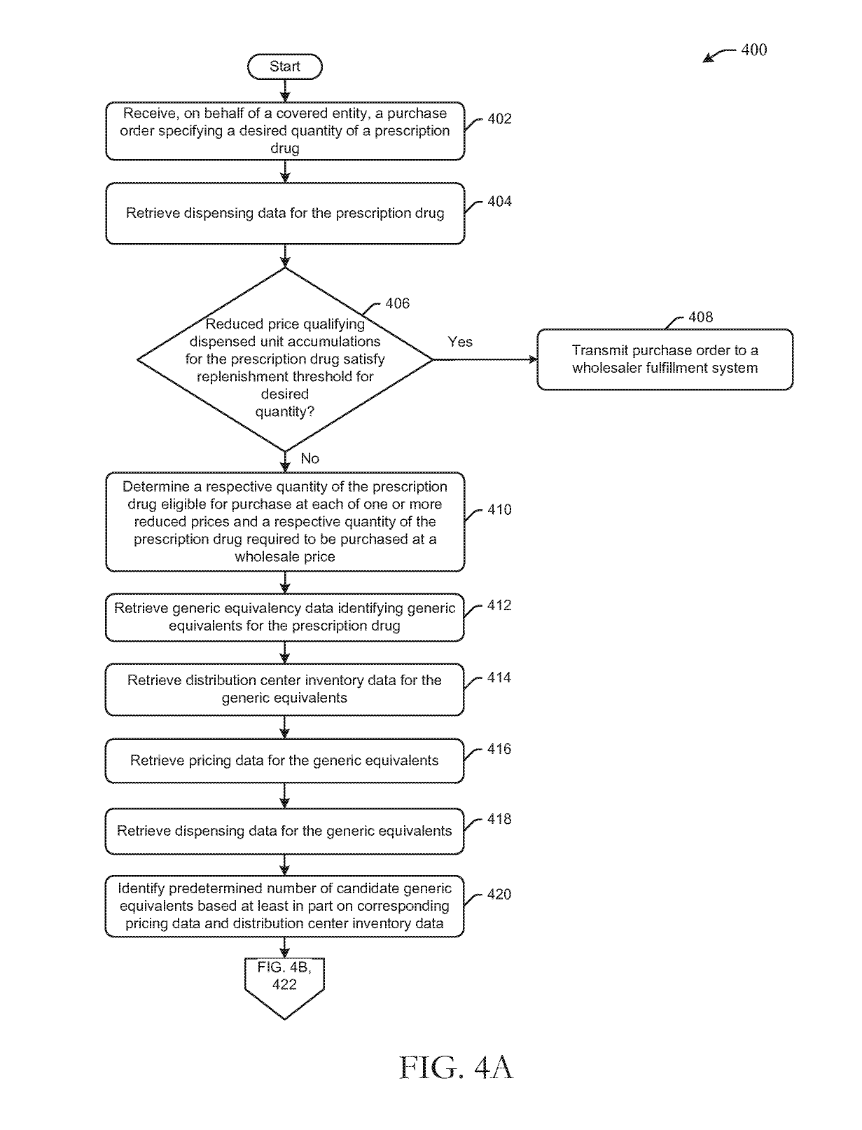

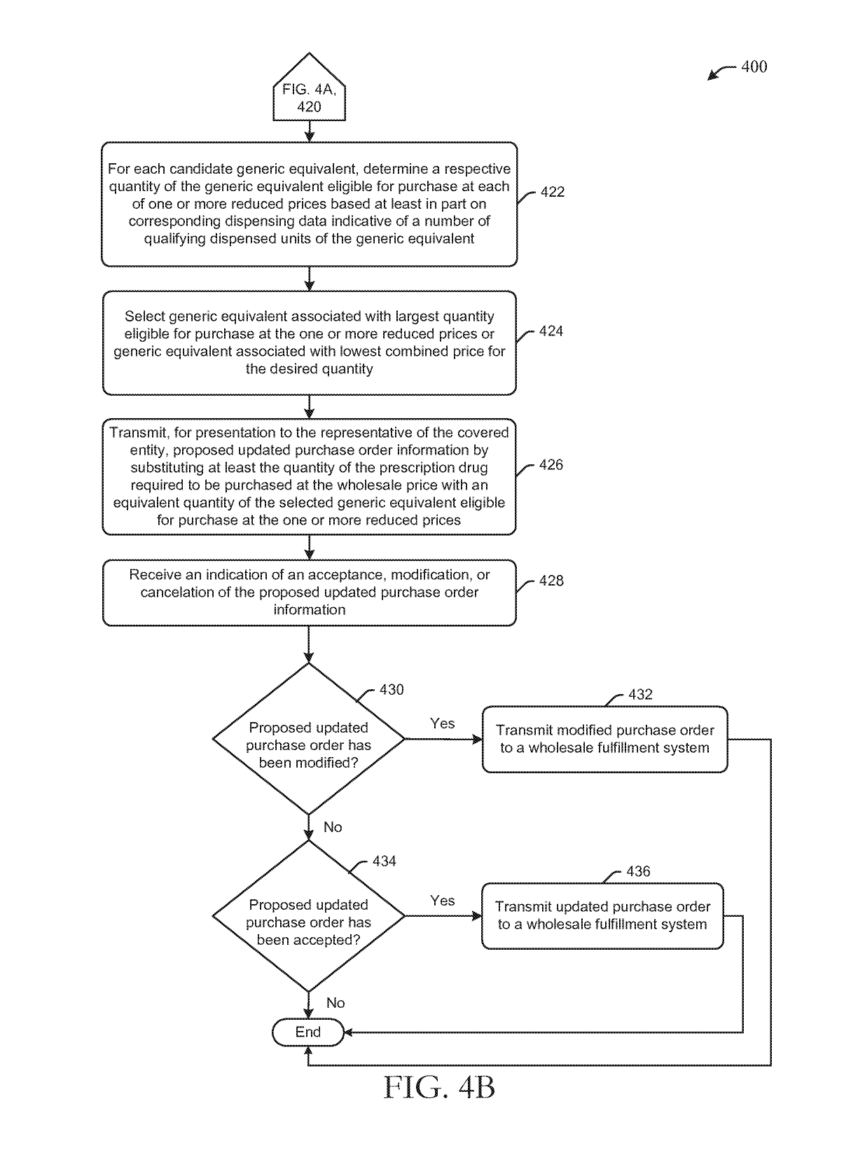

FIG. 3 is an illustrative hybrid system and data flow diagram depicting example data communications in connection with a purchase price optimization for a prescription product purchase order in accordance with one or more example embodiments of the disclosure. FIGS. 4A-4B are process flow diagrams of an illustrative method 400 for performing a purchase price optimization for a prescription product purchase order in accordance with one or more example embodiments of the disclosure.

One or more operations of the method 400 may be described herein as being performed by the price optimization computer 200, or more specifically, one or more program modules executing on the price optimization computer 200 such as, for example, the price optimization module(s) 218, the candidate generic equivalents determination module(s) 220, and/or the generic equivalent selection module(s) 222. It should be appreciated, however, that any of the operations of the method 400 may be performed by another device or component of the system architecture 100 such as, for example, the web portal host computer 104, one or more of the other computer(s) 112, or the like. In addition, it should be appreciated that processing performed in response to execution of computer-executable instructions provided as part of an application, program module, or the like (e.g., computer-executable instructions of the price optimization module(s) 218) may be interchangeably described herein as being performed by the application or the program module itself, by a device on which the application, program module, or the like is executing, or by a system that includes such a device. While the operations of the method 400 may be described in the context of the illustrative system architecture 100 and the illustrative device configuration depicted in FIG. 2, it should be appreciated the method 400 may be implemented in connection with numerous other architectural and device level configurations.

Referring to FIGS. 3 and 4A in conjunction with each other, at block 402, the price optimization computer 200 may receive, on behalf of a covered entity, a purchase order 302 specifying a desired quantity of a prescription drug. For ease of explanation, the purchase order 302 will be described as specifying a desired quantity for only a single prescription drug; however, it should be appreciated that the purchase order 302 may specify desired quantities for multiple prescription drugs. The purchase order 302 may be submitted, for example, via the web portal 116. More specifically, a user 108 (e.g., a wholesale purchaser) acting on behalf of the covered entity may access the web portal 116 using the client application 118 executable on a covered entity device 106, and may select a prescription drug and a desired quantity and submit the purchase order 302 via the web portal 116.

At block 404, upon receipt of the purchase order 302, the price optimization computer 200 may retrieve dispensing data 304 for the prescription drug. The dispensing data 304 may be included in the dispensing data 122 corresponding to a variety of prescription drugs or generic equivalents. The dispensing data 304 may have been previously received as part of a drug utilization file or as part of healthcare claim transaction data. Alternatively, the dispensing data 304 may be received in association with the purchase order 302 or responsive to a request generated by the price optimization computer 200.

At block 406, computer-executable instructions of the price optimization module(s) 218 may be executed to determine, based on dispensing data 304 for the prescription drug by the covered entity, whether the covered entity has accumulated enough qualifying dispense units to satisfy a replenishment threshold for the desired quantity of the prescription drug. For example, the purchase order may be for 10 bottles of a prescription drug dispensed in capsule form where each bottle contains 100 tablets. As such, in this illustrative example, the replenishment increment threshold is 100 and the replenishment threshold for the desired quantity specified in the purchase order is 1000.

In response to a positive determination at block 406, the covered entity may be eligible to replenish its inventory with the entire desired quantity of the drug at the 340B price, and the method 400 may proceed to block 408 where the price optimization computer 408 may transmit or direct transmission of the purchase order 302 to a wholesale fulfillment computer 112 for fulfillment. A positive determination may be made at block 406 if the covered entity has accumulated enough qualifying dispensed units to satisfy the replenishment threshold for the desired quantity of the prescription drug (e.g., the dispensing data indicates that at least 1000 tablets were cumulatively dispensed to one or more outpatients).

A negative determination may be made at block 406 if the dispensing data for the prescription drug fails to indicate a sufficient number of qualifying dispensed units of the prescription drug to be eligible to purchase the entire desired quantity of the drug at the 340B price. In response to a negative determination at block 406, the method 400 may proceed to block 410 where computer-executable instructions of the price optimization module(s) 218 may be executed to determine a price/quantity breakdown for the purchase order. More specifically, a respective quantity of the prescription drug eligible for purchase at each of one or more reduced prices (e.g., a 340B price, a GPO price, etc.) may be determined, and a respective quantity of the prescription drug that is required to be purchase at an increased price such as a WAC price may be determined. Continuing with the non-limiting example introduced above, if the covered entity is seeking to purchase 10 100-capsule bottles of a prescription drug, and has only accumulated enough qualifying dispensed units to purchase 2 bottles at the 340B price, the price/quantity breakdown may include 2 bottles eligible for the 340B price, 5 bottles eligible for a GPO price, and 3 bottles that must be purchased at the WAC price. Another example price/quantity breakdown for the prescription drug may include 2 bottles eligible for purchase at the 340B price and 8 bottles that must be purchased at the WAC price. It should be appreciated that the above examples are merely illustrative and not exhaustive.

At block 410, the price optimization computer 200 may retrieve generic equivalency data 304 identifying generic equivalents that exist for the prescription drug. The generic equivalency data 304 may form part of the generic equivalency data 126 corresponding to multiple prescription drugs. The generic equivalency data 126 may include a schedule, listing, mapping, or the like of NDCs for prescription drugs to NDCs for generic equivalents of the prescription drugs. In certain example embodiments, the price optimization computer 200 may access the dispensing data 122 to retrieve, as the generic equivalency data 306, those generic equivalent NDCs that map to the NDC for the prescription drug identified in the purchase order 302. In certain example embodiments, the generic equivalency data 306 for the prescription drug identified in the purchase order 302 may not have been previously stored, but may be received in association with the purchase order 302 (e.g., as part of or in connection with the data feed that identifies the purchase order 302) or responsive to a request generated by the price optimization computer 200.

At block 412, the price optimization computer 200 may retrieve distribution center inventory data 308 corresponding to the generic equivalents identified at block 410. The distribution center inventory data 308 may indicate a respective quantity of each of the generic equivalents that is in stock and available for shipment. The distribution center inventory data 308 may form part of the distribution center inventory data 120 for any number of prescription drugs and/or generic equivalents. The distribution center inventory data 308 may have been previously received and stored as part of the distribution center inventory data 120 or may be received in association with the purchase order 302 (e.g., as part of or in connection with the data feed that identifies the purchase order 302) or responsive to a request generated by the price optimization computer 200.

At block 416, the price optimization computer 200 may retrieve pricing data 310 for the generic equivalents identified at block 410. The pricing data 310 may form part of the pricing data 124 for any number of prescription drugs and/or generic equivalents. The pricing data 310 may indicate 340B pricing, GPO pricing, and/or WAC pricing for each of the generic equivalents identified at block 410. The pricing data 310 may have been previously received and stored as part of the pricing data 124 or may be received in association with the purchase order 302 or responsive to a request generated by the price optimization computer 200. For example, the pricing data 310 may be retrieved at block 416 from database tables stored in one or more of the datastore(s). The database tables containing the pricing data 124 may have been received from, for example, one or more other computers 112 as part of a periodic data feed.

At block 418, the price optimization computer 200 may retrieve dispensing data 312 for the generic equivalents identified at block 410. The dispensing data 312 may be included in the dispensing data 122 corresponding to a variety of prescription drugs or generic equivalents. The dispensing data 312 may have been previously received as part of a drug utilization file or as part of healthcare claim transaction data. Alternatively, the dispensing data 312 may be received in association with the purchase order 302 or responsive to a request generated by the price optimization computer 200.

At block 420, computer-executable instructions of the candidate generic equivalents determination module(s) 220 may be executed to identify a predetermined number of candidate generic equivalents based at least in part on corresponding pricing data 310 and distribution center inventory data 308. More specifically, computer-executable instructions of the candidate generic equivalents determination module(s) 220 may be executed to generate a ranking of the generic equivalents based at least in part on the pricing data 310 and the distribution center inventory data 308. For example, a generic equivalent that has a lower reduced price (e.g., a lower 340B price) may be ranked higher than a generic equivalent that has a higher reduced price. Similarly, if the distribution center data 308 indicates that the distribution center inventory includes a sufficient quantity of a particular generic equivalent to meet the desired quantity of the prescription drug specified in the purchase order, that generic equivalent may be ranked higher than another generic equivalent that is not adequately stocked at the distribution center. A predetermined number (e.g., 10) of highest ranking generic equivalents may be identified as candidates for substituting for at least a portion of the desired quantity of the prescription drug.

Referring now to FIGS. 3 and 4B in conjunction with each other, at block 422, computer-executable instructions of the generic equivalent selection module(s) 222 may be executed to evaluate the dispensing data 312 to determine, for each candidate generic equivalent identified at block 420, a respective quantity of the generic equivalent eligible for purchase at each of one or more reduced prices. For example, the generic equivalent selection module(s) 222 may evaluate the dispensing data 312 to determine the number of dispensed units of each candidate generic equivalent qualifying for a 340B price, compare the number of qualifying dispensed units against the replenishment increment threshold for the generic equivalent (which may be the same as the replenishment increment threshold for the corresponding prescription drug), and determine the number of replenishment increments eligible for the 340B price. A similar process may be executed to determine, for each candidate generic equivalent, the number of replenishment increments eligible for a reduced price under another drug pricing program (e.g., a GPO price). In certain example embodiments, the number of replenishment increments that must be purchased at a WAC price may also be determined for one or more of the candidate generic equivalents.

At block 424, computer-executable instructions of the generic equivalent selection module(s) 222 may be executed to identify and select a candidate generic equivalent associated with a largest quantity (e.g., a highest number of replenishment increments) eligible for purchase at the 340B price. Alternatively, computer-executable instructions of the generic equivalent selection module(s) 222 may be executed to identify and select a candidate generic equivalent associated with a lowest combined price of the desired quantity. In still other example embodiments, multiple candidate generic equivalents may be selected if, for example, a total quantity of the multiple candidate generic equivalents eligible for 340B pricing meets or exceeds the desired quantity of the prescription drug identified in the purchase order 302.

Referring again to the non-limiting example involving a purchase order for 10 100-tablet bottles of a prescription drug, and assuming that two generic equivalents (e.g., generic equivalent A and generic equivalent B) have been identified as candidates, the dispensing data for generic equivalent A may indicate that the covered entity dispensed 612 qualifying dispensed units of generic equivalent A and 815 qualifying dispensed units of generic equivalent B. In such an example scenario, the generic equivalent selection module(s) 222 may determine that 6 bottles of generic equivalent A can be purchased at the corresponding 340B price, 4 bottles can be purchased at a GPO price, and no bottles must be purchased at the WAC price. Similarly, for generic equivalent B, the generic equivalent selection module(s) 222 may determine that 8 bottles of generic equivalent B can be purchased at the corresponding 340B price and that the remaining 2 bottles must be purchased at the WAC price.

In the example scenario described above, since a greater quantity of generic equivalent B is eligible for purchase at the 340B price as compared to generic equivalent A, generic equivalent B may be selected at block 424 as the optimized generic equivalent to potentially substitute for the prescription drug originally specified in the purchase order 302. In alternative embodiments, if the combined price of the purchase of 10 bottles of generic equivalent A is less than the combined price of the purchase of 10 bottles of generic equivalent B (which may be the case if the WAC price for generic equivalent B is significantly more than the GPO price for generic equivalent A), generic equivalent A may instead be selected as the optimized generic equivalent to potentially substitute for the prescription drug originally specified in the purchase order 302.

At block 426, upon selecting one or more generic equivalents at block 424, computer-executable instructions of the price optimization module(s) 218 may be executed to generate proposed updated purchase order information 314 by substituting at least the quantity of the prescription drug required to be purchased at the WAC price for an equivalent quantity of the selected one or more generic equivalents eligible for purchase at a reduced price such as the 340B price, and may communicate the proposed updated purchase order information 314 for presentation to the representative of the covered entity that submitted the original purchase order 302. More specifically, the proposed updated purchase order information may be transmitted to the web portal host computer 104 for presentation to the representative of the covered entity on a user interface of the web portal 116 rendered on the client application 118.

The representative (e.g., a wholesale purchaser) acting on behalf of the covered entity may be provided with the option of accepting the proposed purchase order, modifying it, or cancelling it. At block 428, the price optimization computer 200 may receive an indication 316 of an acceptance, modification, or cancelation of the proposed updated purchase order information 314.

At block 430, the price optimization computer 200 may determine whether the received indication 314 corresponds to a modification of the proposed updated purchase order information 314. Modifications to the proposed purchased order information may include removing any replenishment increments that must be purchased at the WAC price that might remain in the proposed purchase order information 314. In response to a positive determination at block 430, the price optimization computer 200 may, at block 432, transmit or direct transmission of the modified purchase order to a wholesale fulfillment system 112 for fulfillment, at which point, the method 400 may end.

In response to a negative determination at block 430, the price optimization computer 200 may determine whether the indication 314 corresponds to an acceptance of the proposed updated purchase order information 314. In response to a positive determination at block 434, the price optimization computer 200 may, at block 436, transmit or direct transmission of the accepted purchase order to a wholesale fulfillment system 112 for fulfillment, at which point, the method 400 may end.

In response to a negative determination at block 434, the price optimization computer 200 may determine that the proposed updated purchase order information 314 has been rejected and that the purchase order 302 has been canceled, at which point, the method 400 may end.

In certain other example embodiments, a modified or accepted purchase order may be communicated via the web portal to the wholesale fulfillment system without the further involvement of the price optimization computer 200. In such embodiments, however, the price optimization computer 202 may nonetheless receive a notification that the proposed order has been accepted or modified. Upon receiving an indication that a purchase order has been submitted (e.g., a proposed purchase order has been accepted or modified and submitted for fulfillment), the price optimization computer 200 may update corresponding dispensing data to remove any accumulations of qualifying dispensed units that served as a basis for obtaining a replenishment increment of a drug in the submitted purchase order.

While example embodiments described herein may indicate that a particular generic equivalent may be chosen to replace at least a portion of the desired quantity of a prescription drug in a purchase order, it should be appreciated that various combinations of generic equivalents may be chosen in certain example embodiments. Referring again to the non-limiting example introduced above, various combinations of generic equivalent A and generic equivalent B may be purchased at the 340B price in a quantity sufficient to match the entire desired quantity of the prescription drug. For example, if an amount of qualifying dispensed units accumulated for the prescription drug are insufficient to satisfy the minimum replenishment threshold for even a single replenishment increment at the 340B price, the purchase order may be updated to entirely remove the original prescription product and to instead include, for example, 5 bottles of generic equivalent B at the 340B price and 5 bottles of generic equivalent A at the 340B price (or any other suitable combination). In addition, in certain example embodiments, even if some portion of the desired quantity of the prescription drug is available for purchase at the 340B price, the prescription drug may nonetheless be entirely substituted for one or more generic equivalents that are eligible for reduced pricing for the entire desired quantity. In still other embodiments, an amount of a generic equivalent equal to the entire desired quantity of the prescription drug may be substituted for the prescription drug even if some portion of the generic equivalent must be purchased at a higher price such as the WAC price.

The operations described and depicted in the illustrative method of FIGS. 4A-4B may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 4A-4B may be performed. In addition, various modifications, alternatives, and so forth to the illustrative data flows of FIG. 3 are within the scope of this disclosure.

While certain example embodiments disclosed herein have been described as involving the transmission or receipt of data between the price optimization computer 200 and other illustrative components of the illustrative architecture 100, in certain other example embodiments, such transmissions may be internal transmissions occurring within the price optimization computer 200 or may be omitted altogether. Further, while example embodiments described herein with reference to FIGS. 1-4B describe certain example operations as occurring at or being performed by one or more price optimization computers 200 or certain example data transmissions as originating at or being received by one or more price optimization computers 200, in alternative example embodiments, such example data transmissions may originate at or may be received by, or such example operations may occur at or may be performed by, the web portal host computer(s) 104, the covered entity device(s) 106, the distribution center computer(s) 110, the other computer(s) 112, another separate and distinct computer or computer system, a combination of two or more such devices, and/or a combination of one or more such devices along with one or more price optimization computers 200. In such alternate example embodiments, certain transmission/receiving steps and/or certain data transmissions described above with reference to FIGS. 1-4B may be omitted while others may be added, as will be understood by one of ordinary skill in the art. The intent being that, in alternate example embodiments, any of the devices/computers described and depicted with respect to FIG. 1 are capable of performing any one or more operations or originating/receiving any one or more data transmissions of any of the methods described with reference to FIGS. 1-4B.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program modules, applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method, comprising:
receiving, by one or more computers comprising one or more processors and on behalf of a requestor, a request for a desired quantity of a prescription product;
determining, by the one or more computers, that at least a portion of the desired quantity of the prescription product is not eligible for a first reduced price in accordance with a drug pricing program;
identifying, by the one or more computers, one or more candidate generic products corresponding to the prescription product;
selecting, by the one or more computers, at least one candidate generic product from among the one or more candidate generic products based at least in part on an eligibility of each of the at least one candidate generic product for a respective corresponding reduced price in accordance with the drug pricing program;
generating, by the one or more computers, proposed order information, wherein generating comprises substituting the at least a portion of the desired quantity of the prescription product that is not eligible for the first reduced price with an equivalent quantity of the at least one candidate generic product; and
transmitting, by the one or more computers, the proposed order information for presentation to the requestor.

2. The method of claim 1, wherein determining that at least a portion of the desired quantity of the prescription product is not eligible for the first reduced price comprises:
retrieving, by the one or more computers, dispensing data for the prescription product;
evaluating, by the one or more computers, the dispensing data for the prescription product to determine a number of dispensed units that qualify for the first reduced price;
determining, by the one or more computers, a replenishment threshold corresponding to the desired quantity; and
determining, by the one or more computers, that the number of dispensed units does not meet or exceed the replenishment threshold.

3. The method of claim 1, wherein the replenishment threshold comprises a summation of multiple replenishment increment thresholds.

4. The method of claim 1, wherein identifying one or more candidate generic products comprises:
determining, by the one or more computers, an identifier of the prescription product; and
accessing, by the one or more computers, generic equivalency data indicating a correspondence between the identifier of the prescription product and one or more additional identifiers associated with the identifier of the prescription product;
identifying, by the one or more computers, a set of generic products corresponding to the prescription product based at least in part on the correspondence between the identifier of the prescription product and one or more additional identifiers;
accessing, by the one or more computers, at least one of pricing data associated with the set of generic products or distribution center inventory data associated with the set of generic products; and
identifying, by the one or more computers, the one or more candidate generic products from the set of generic products based at least in part on the at least one of the pricing data or the distribution center inventory data.

5. The method of claim 1, wherein the at least one candidate generic product comprises a first candidate generic product, and wherein selecting the first candidate generic product comprises:
accessing, by the one or more computers, dispensing data for the first candidate generic product;
determining, by the one or more computers, a quantity of the first candidate generic product eligible for the respective reduced price corresponding to the first candidate generic product; and
determining, by the one or more computers, that the quantity of the first candidate generic product is greater than or equal to the desired quantity of the prescription product.

6. The method of claim 1, wherein the at least one candidate generic product comprises a first candidate generic product, and wherein selecting the first candidate generic product comprises:
accessing, by the one or more computers, dispensing data for the first candidate generic product;
determining, by the one or more computers, a quantity of the first candidate generic product eligible for the respective reduced price corresponding to the first candidate generic product; and
determining, by the one or more computers, that the quantity of the first candidate generic product is greater than a respective quantity of each other candidate generic product eligible for the respective reduced price corresponding to each other candidate generic product.

7. The method of claim 1, wherein the at least one candidate generic product comprises a first candidate generic product and a second candidate generic product, and wherein selecting the first candidate generic product and the second candidate generic product comprises:
accessing, by the one or more computers, dispensing data for the first candidate generic product and the second candidate generic product;
determining, by the one or more computers, a first quantity of the first candidate generic product eligible for the respective reduced price corresponding to the first candidate generic product and a second quantity of the second candidate generic product eligible for the respective reduced price corresponding to the second candidate generic product; and
determining, by the one or more computers, that the sum of the first quantity of the first candidate generic product and the second quantity of the second candidate generic product is greater than or equal to the desired quantity of the prescription product.

8. The method of claim 1, wherein the at least one candidate generic product comprises a first candidate generic product, and wherein selecting the first candidate generic product comprises:
accessing, by the one or more computers, dispensing data for the first candidate generic product;
determining, by the one or more computers, a quantity of the first candidate generic product eligible for the respective reduced price corresponding to the first candidate generic product; and
determining, by the one or more computers, that the quantity of the first candidate generic product is greater than or equal to the at least a portion of the desired quantity of the prescription product that is not eligible for the first reduced price.

9. The method of claim 1, wherein the first reduced price is a first 340B price, and wherein the respective corresponding reduced price for each of the at least one candidate generic product is a respective corresponding 340B price.

10. The method of claim 1, wherein the at least a portion of the prescription product that is not eligible for the first reduced price must be purchased at a Wholesale Acquisition Cost (WAC) price, and wherein the respective reduced price corresponding to each of the at least one candidate generic product is a price less than the WAC price.

11. A system, comprising;
at least one memory storing computer-executable instructions; and
at least one processor configured to access the at least one memory and to execute the computer-executable instructions to:
receive, on behalf of a requestor, a request for a desired quantity of a prescription product;
determine that at least a portion of the desired quantity of the prescription product is not eligible for a first reduced price in accordance with a drug pricing program;
identify one or more candidate generic products corresponding to the prescription product;
select at least one candidate generic product from among the one or more candidate generic products based at least in part on an eligibility of each of the at least one candidate generic product for a respective corresponding reduced price in accordance with the drug pricing program;
generate proposed order information, wherein generating comprises substituting the at least a portion of the desired quantity of the prescription product that is not eligible for the first reduced price with an equivalent quantity of the at least one candidate generic product; and
transmit the proposed order information for presentation to the requestor.

12. The system of claim 11, wherein the at least one processor is configured to determine that at least a portion of the desired quantity of the prescription product is not eligible for the first reduced price by executing the computer-executable instructions to:
retrieve dispensing data for the prescription product;
evaluate the dispensing data for the prescription product to determine a number of dispensed units that qualify for the first reduced price;
determine a replenishment threshold corresponding to the desired quantity; and
determine that the number of dispensed units does not meet or exceed the replenishment threshold.

13. The system of claim 11, wherein the replenishment threshold comprises a summation of multiple replenishment increment thresholds.

14. The system of claim 11, wherein the at least one processor is configured to identify the one or more candidate generic products by executing the computer-executable instructions to:
determine an identifier of the prescription product; and
access generic equivalency data indicating a correspondence between the identifier of the prescription product and one or more additional identifiers associated with the identifier of the prescription product;
identify a set of generic products corresponding to the prescription product based at least in part on the correspondence between the identifier of the prescription product and one or more additional identifiers;
access at least one of pricing data associated with the set of generic products or distribution center inventory data associated with the set of generic products; and
identify the one or more candidate generic products from the set of generic products based at least in part on the at least one of the pricing data or the distribution center inventory data.

15. The system of claim 11, wherein the at least one candidate generic product comprises a first candidate generic product, and wherein the at least one processor is configured to select the first candidate generic product by executing the computer-executable instructions to:
access dispensing data for the first candidate generic product;
determine a quantity of the first candidate generic product eligible for the respective reduced price corresponding to the first candidate generic product; and
determine that the quantity of the first candidate generic product is greater than or equal to the desired quantity of the prescription product.

16. The system of claim 11, wherein the at least one candidate generic product comprises a first candidate generic product, and wherein the at least one processor is configured to select the first candidate generic product by executing the computer-executable instructions to:
access dispensing data for the first candidate generic product;
determine a quantity of the first candidate generic product eligible for the respective reduced price corresponding to the first candidate generic product; and
determine that the quantity of the first candidate generic product is greater than a respective quantity of each other candidate generic product eligible for the respective reduced price corresponding to each other candidate generic product.

17. The system of claim 11, wherein the at least one candidate generic product comprises a first candidate generic product and a second candidate generic product, and wherein the at least one processor is configured to select the first candidate generic product and the second candidate generic product by executing the computer-executable instructions to:
access dispensing data for the first candidate generic product and the second candidate generic product;
determine a first quantity of the first candidate generic product eligible for the respective reduced price corresponding to the first candidate generic product and a second quantity of the second candidate generic product eligible for the respective reduced price corresponding to the second candidate generic product; and
determine that the sum of the first quantity of the first candidate generic product and the second quantity of the second candidate generic product is greater than or equal to the desired quantity of the prescription product.

18. The system of claim 11, wherein the at least one candidate generic product comprises a first candidate generic product, and wherein the at least one processor is configured to select the first candidate generic product by executing the computer-executable instructions to:
access dispensing data for the first candidate generic product;
determine a quantity of the first candidate generic product eligible for the respective reduced price corresponding to the first candidate generic product; and
determine that the quantity of the first candidate generic product is greater than or equal to the at least a portion of the desired quantity of the prescription product that is not eligible for the first reduced price.

19. The system of claim 11, wherein the first reduced price is a first 340B price, and wherein the respective corresponding reduced price for each of the at least one candidate generic product is a respective corresponding 340B price.

20. The system of claim 11, wherein the at least a portion of the prescription product that is not eligible for the first reduced price must be purchased at a Wholesale Acquisition Cost (WAC) price, and wherein the respective reduced price corresponding to each of the at least one candidate generic product is a price less than the WAC price.
